(19) United States
(12) Patent Application Publication
(10) Pub. No.: US 2025/0276431 A1
(43) Pub. Date: Sep. 4, 2025

(54) WORK IMPLEMENT STORAGE SYSTEM

(71) Applicant: Techtronic Cordless GP, Anderson, SC (US)

(72) Inventors: Jeremy Fedrigon, Greenville, SC (US); Wai Yip Siu, Ho Chi Minh City (VN); Gai She Zhang, Dongguan (CN)

(21) Appl. No.: 19/066,276

(22) Filed: Feb. 28, 2025

Related U.S. Application Data
(60) Provisional application No. 63/560,910, filed on Mar. 4, 2024.

(51) Int. Cl. B25H 3/00; B25F 5/02; B25H 3/06

(52) U.S. Cl. CPC B25H 3/003; B25F 5/029; B25H 3/006; B25H 3/06

(57) ABSTRACT

A tool or storage vessel including: a body; an interface coupled to the body and including an attachment structure; a work implement storage system removably coupled to the interface, wherein the work implement storage system including: a first member defining a first plurality of receiving areas each configured to receive one of a plurality of work implements; and a second member defining a second plurality of receiving areas each configured to receive one of the plurality of work implements, wherein the first and second members are stacked together when the work implement storage system is coupled to the interface such that the first member is disposed between the second member and the tool or storage vessel, and wherein the second member is rotatable relative to the interface to permit user access to one or more of the work implements received in the first plurality of receiving areas.

### CROSS-REFERENCE TO RELATED APPLICATIONS

The present application claims priority to U.S. Provisional Application Ser. No. 63/560,910 filed on Mar. 4, 2024, the disclosure of which is incorporated by reference herein in its entirety.

### FIELD

The present disclosure relates generally to work implement storage systems, and more particularly to portable and interchangeable work implement storage systems and related components for use storing work implements at a tool and/or a storage vessel when not actively used with the tool.

### BACKGROUND

Many tools are designed for use with interchangeable work implements. The work implements are swappable and interchangeable via a receiving interface of the tool. For example, drills typically include a motor that rotatably drives a chuck. The chuck supports a removable work implement, such as, for example, a drill bit and/or a driver bit. The chuck can be opened and closed by the operator (user) to engage and/or release the work implement to allow for swapping between different types and sizes of work implements.

The advantage of swapping between work implements is best appreciated when paired with quick access to different types work implement. Traditionally, quick access to different types of work implements was achieved by carrying a work belt or tool chest around a jobsite. The operator could reach into a receptacle of the work belt to obtain the desired work implement. However, work belts can be cumbersome and frequently fail to provide easy access to a desired work implement. Meanwhile, tool chests are often heavy and difficult to keep organized.

### BRIEF DESCRIPTION

Aspects and advantages of the invention in accordance with the present disclosure will be set forth in part in the following description, or may be obvious from the description, or may be learned through practice of the technology.

In accordance with one embodiment, a tool or storage vessel is provided. The tool or storage vessel includes a body; an interface coupled to the body and including an attachment structure; a work implement storage system removably coupled to the interface, wherein the work implement storage system comprises: a first member defining a first plurality of receiving areas each configured to receive one of a plurality of work implements; and a second member defining a second plurality of receiving areas each configured to receive one of the plurality of work implements, wherein the first and second members are stacked together when the work implement storage system is coupled to the interface such that the first member is disposed between the second member and the tool or storage vessel, and wherein the second member is rotatable relative to the interface to permit user access to one or more of the work implements received in the first plurality of receiving areas.

In accordance with another embodiment, a work implement storage system is provided. The work implement storage system includes a first member comprising: a body defining a first plurality of receiving areas each configured to receive a work implement of a plurality of work implements; and a first attachment structure; a second member comprising: a body defining a second plurality of receiving areas each configured to receive another work implement of the plurality of work implements; a second attachment structure; and a third attachment structure, wherein the first and second members stack relative to one another, wherein in a stacked state the first attachment structure is disposed between the second and third attachment structures, and wherein the first, second, and third attachment structures are configured to couple the first and second members to a tool or storage vessel.

In accordance with another embodiment, a method of using a tool is provided. The method includes selecting a desired work implement for use with a tool based on a work operation; identifying a location of the desired work implement in an inboard member of a work implement storage system coupled to the tool or a storage vessel; rotatably displacing an outboard member of the work implement storage system to provide user access to the inboard member; pivoting the desired work implement relative to a receiving area in which the desired work implement is disposed from a stored position to an access position; withdrawing the desired work implement from the receiving area with the desired work implement in the access position; rotatably displacing the outboard member to an original position; and using the tool with the desired work implement to perform the work operation.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of a work implement storage system as seen in a stacked configuration in accordance with embodiments of the present disclosure;

FIG. 2 is a side view of the work implement storage system as seen in an unstacked configuration with first and second members of the work implement storage system separated from one another in accordance with embodiments of the present disclosure;

FIG. 3 is a perspective view of the work implement storage system as seen in an unstacked configuration with the first and second members separated from one another in accordance with embodiments of the present disclosure;

FIG. 4 is a plan view of a storage vessel housing the work implement storage system in accordance with embodiments of the present disclosure;

FIG. 5 is a plan view of the storage vessel housing the work implement storage system when an operator reaches towards a desired work implement retained by the work implement storage system in accordance with embodiments of the present disclosure;

FIG. 6 is a plan view of the storage vessel as seen after the operator rotatably displaces the desired work implement to an access position in accordance with embodiments of the present disclosure;

FIG. 7 is a plan view of the storage vessel as seen after the operator removes the desired work implement from the work implement storage system in accordance with embodiments of the present disclosure;

FIG. 8 is a plan view of the storage vessel as seen after the operator reinserts the desired work implement into the work implement storage system after completing a work operation using the desired work implement in accordance with embodiments of the present disclosure;

FIG. 9 is a plan view of the storage vessel as seen when the operator grips an outboard member of the work implement storage system in preparation to rotatably displace the outboard member to achieve access to a work implement disposed at an inboard member of the work implement storage system in accordance with embodiments of the present disclosure;

FIG. 10 is a plan view of the storage vessel as seen with the outboard member rotatably displaced to permit access to the work implement disposed at the inboard member in accordance with embodiments of the present disclosure;

FIG. 11 is a plan view of the storage vessel as seen when an operator rotatably displaces the work implement disposed at the inboard member in accordance with embodiments of the present disclosure;

FIG. 12 is a perspective view of a work implement storage system in accordance with other embodiments of the present disclosure;

FIG. 13 is an exploded view of the work implement storage system of FIG. 12 as seen with first and second members of the work implement storage system separated from one another in accordance with embodiments of the present disclosure;

FIG. 14 is a rear perspective view of the second member of the work implement storage system of FIG. 12 in accordance with embodiments of the present disclosure;

FIG. 15 is a plan view of a cover of a storage vessel retaining the work implement storage system of FIG. 12 as seen with the work implement storage system in a closed configuration in accordance with embodiments of the present disclosure;

FIG. 16 is a plan view of the cover of the storage vessel retaining the work implement storage system of FIG. 12 as seen with the work implement storage system in an open position to permit access to an inboard member of the work implement storage system in accordance with embodiments of the present disclosure;

FIG. 17 is a plan view of the storage vessel after the operator rotatably displaces an outboard member to a closed position and pushes the outboard member to lock the work implement storage system in the closed position in accordance with embodiments of the present disclosure;

FIG. 18 is an exploded perspective view of a tool, an interface, and the work implement storage system of FIG. 1 in accordance with embodiments of the present disclosure;

FIG. 19 is a perspective view of the tool, the interface, and the work implement storage system of FIG. 1 as seen with the outboard member of the work implement storage system rotatably displaced to a position to allow an operator access to an inboard member of the work implement storage system in accordance with embodiments of the present disclosure; and

FIG. 20 is a perspective view of a storage vessel including the work implement storage system of FIG. 1 with circular receiving areas for receiving circular shanks of certain work implements in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, work implement storage systems described herein provide high-density storage for work implements (such as drivers, drill bits, or the like). The work implements are insertable into receiving areas defined by the work implement storage system. The receiving areas are sized and shaped such that an operator (user) can readily select and remove work implements from the receiving areas. The receiving areas are configured to receive different types of work implements. For example, the work implement storage system can hold different sized drill bits, different driver bits, and/or the like. The receiving areas can be sized and/or shaped to accommodate various shaped and sized shanks of the work implements. For example, at least some of the receiving areas can define different dimensions associated with different shank diameters. Alternatively, or in addition, some of the receiving areas can define uniform dimensions associated with a common shank type.

The work implement storage system is attachable directly or indirectly, to a tool, such as a drill. As the tool moves around a worksite, the work implement storage system ensures that the work implements are always ready for use with the tool without the operator having to dig through a tool belt or a toolbox to find a desired work implement. For example, the operator may first select and remove a suitable drill bit from the work implement storage system to form a pilot hole. After forming the pilot hole, the operator can reinsert the drill bit into the work implement storage system and then select and remove a driver bit to drive a fastener into the pilot hole. The operator can then reinsert the driver bit into the work implement storage system. The operator can continue to cycle between work implements from the work implement storage system during the course of the work operation. Because the work implement storage system is disposed at the tool itself, less time is required to transition between work implements.

In some implementations, the work implement storage system may include a kit that is configurable by the operator. For example, the operator can customize the type and/or arrangement of work implements carried by the work implement storage system. In other implementations, the work implement storage system may include a fixed configuration where certain work implements are receivable in certain receiving areas and other work implements are receivable in other receiving areas.

The work implement storage system can interface with a storage vessel, such as a container, box, or the like. The operator can switch the work implement storage system between the tool and the storage vessel, for example, based on the type or scope of operation being performed, the number of different work implements needed to complete a work operation, personal preference, or the like. For example, when arriving at a worksite, the operator can remove a work implement storage system from the storage vessel and attach the work implement storage system to the tool. As the operator moves around the worksite, the work implements carried by the work implement storage system travel with the tool for quick access. After completing the work operation (e.g., at the end of the day), the operator can remove the work implement storage system from the tool and reattach the work implement storage system to the storage vessel. The storage vessel can securely retain the work implement storage system (and the work implements) until such time that the operator again desires to have the work implements proximate to the tool.

The storage vessel can carry a plurality of work implement storage systems. Each work implement storage system can be configured with a different set of work implements. The operator can select between the work implement storage systems based on the type of work operation being performed. For example, a first work implement storage system might be configured with work implements for use with wood, like drill bits and driver bits designed for use in wood-based projects. A second work implement storage system might be configured with work implements for use with ceramics, like drill bits designed from use in ceramic-based projects. A third work implement storage system might be configured with work implements for use with sheet metal. A fourth work implement storage system might be configured with work implements for a combination of work operations, like some metal drill bits and some wood drill bits. Additional types of work operations may be selectively configurable by inserting work implements associated with those operations into another work implement storage system. Yet further, the different work implement storage systems may be instead, or additionally, be sorted by size. For example, small diameter drill bits may be configured on a first work implement storage system and larger diameter drill bits may be configured on a second work implement storage system. The operator can select between the work implement storage systems in view of the work operation to be performed. As such, the operator can appropriately configure the tool based on need and attach only the type of work implements needed for a particular work operation.

By allowing the operator to “load” and “unload” the work implement storage system from the tool and to secure unloaded work implement storage systems in the storage vessel, the work implements are both accessible for quick access and safely secured when not actively in use. The storage vessel and/or the work implement storage systems can be labeled to quickly identify the type of work implement(s) contained by each of the work implement storage systems. The operator can thus quickly select between different work implements and rapidly configure their tool for the particular work operation.

In some implementations, the same feature or features of the work implement storage system are used to couple the work implement storage system to the tool and the storage vessel. That is, common hardware may be used to attach the work implement storage system(s) to both the tool and the storage vessel. Use of common hardware can reduce weight and bulkiness of the work implement storage system(s).

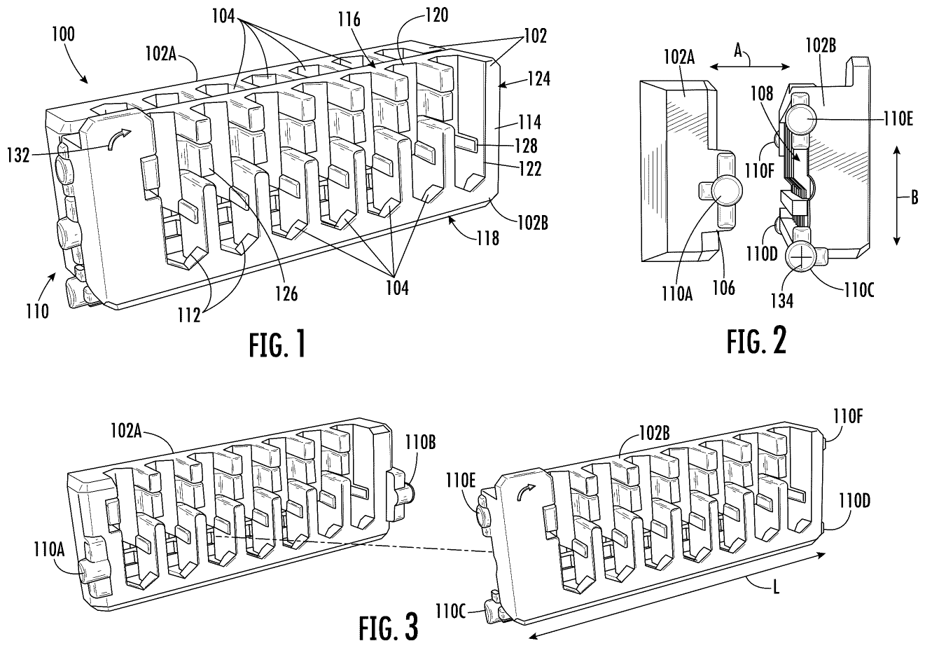

Referring now to the drawings, FIGS. 1 to 3 illustrate a work implement storage system 100 (hereinafter referred to as “the storage system 100”) in accordance with an example embodiment. More particularly, FIG. 1 illustrates a perspective view of the work implement storage system; FIG. 2 illustrates a side view of separate members of the work implement storage system as seen when the separate members are separated from one another; and FIG. 3 illustrates an exploded perspective view of the separate members as seen when the separate members are separated from one another. While FIGS. 1 to 3 illustrate two separate members forming the storage system 100, it is contemplated that fewer or additional members may be used.

The storage system 100 includes a plurality of separate members each configured to support one or more (such as a plurality of) work implements, such as one or more drill bits, driver bits, or the like. The separate member(s) may be configurable to support different types of work implements associated with different types of tools. The following description provides embodiments directed specifically to members in the form of bit bars 102 for use with a handheld drill to store drill and driver bits. However, the separate members are not intended to be limited to bit bars 102 for use with drill and driver bits and may be adapted for use with other types of tools, such as rotary saws, reciprocating saws, jig saws, track saws, masonry saws, shears, blowers, vacuums, sanders, impact wrenches, angle grinders, adhesive applicators, media blasting equipment, nail guns and staplers, routers, soldering equipment, multi-tools, pumps, ratchets, mixers, or the like. Each of these tools may include swappable work implements which. Inactive work implements can be stored using the storage system 100 described herein. It should be understood that the term bit bar 102 may refer to members usable with all types of different tools.

The storage system 100 can include a plurality of bit bars 102, such as for example, two bit bars, three bit bars, four bit bars, etc. Two bit bars 102 are depicted in FIGS. 1 to 3, including a first bit bar 102A and a second bit bar 102B. The first bit bar 102A may be referred to as an inboard (inner) bit bar and the second bit bar 102B may be referred to as an outboard (outer) bit bar, both in relation to the tool or storage vessel currently retaining (holding) the storage system 100. That is, the first bit bar 102A may be disposed between the tool or vessel and the second bit bar 102B so as to assume an inboard relationship with respect to the second bit bar 102B. In an embodiment, yet one or more further outboard bit bars (not illustrated) can be coupled to the second bit bar 102B. For example, a third bit bar (not illustrated) can be coupled to an outboard side of the second bit bar 102B, a fourth bit bar (not illustrated) can be optionally coupled to an outboard side of the second bit bar 102B and/or the third bit bar, etc. At least some of the bit bars 102A, B, . . . N can be stacked on top of one another in a close fit arrangement.

In an embodiment, one or more portions of the first bit bar 102A can overlap with certain portions of the second bit bar 102B in a stack direction A (FIG. 2) such that the overlapping portion(s) of the first and second bit bars 102A, 102B nest relative to one another. Nesting, i.e., overlapping portions of the bit bars 102 with one another in a direction parallel to the stack direction A, can increase rigidity of the individual bit bars 102, prevent vibrational noise and movement of the bit bars 102 relative to each other and/or the tool, and allow for low profile interfacing between the bit bars 102. In some instances, the bit bars 102 can be coupled to one another through their nested (overlapping) portions. For example, the overlapping portions of the bit bars 102 can form an interference fit that restricts separation of the bit bars 102 from one another.

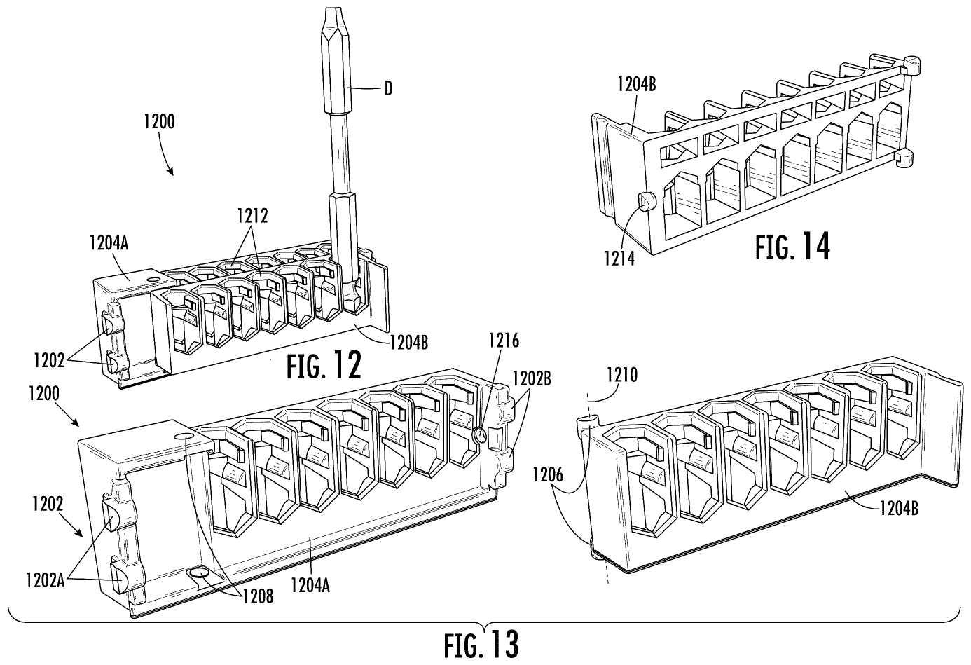

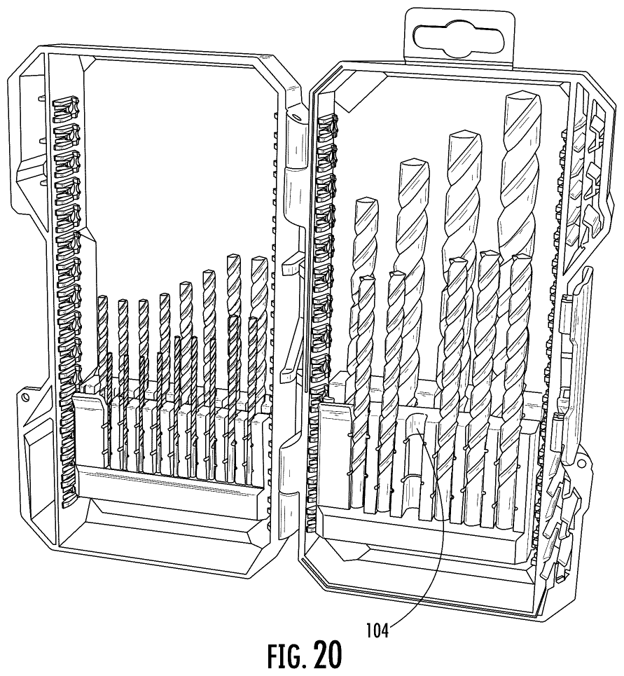

Work implements, such as the driver D depicted in FIG. 12, can be individually received by receiving areas 104. Each of the first and second bit bars 102A, 102B defines a plurality of receiving areas 104. The receiving areas 104 may be fungible such that work implements (e.g., the driver D) can be received at any one of the receiving areas 104. Alternatively, at least one of the receiving areas 104 can be configured to receive a first type of work implement and at least one receiving area 104 can be configured to receive a second type of work implement different from the first type of work implement. For example, some work implements, e.g., driver bits, have hexagonal shanks whereas other work implements, e.g., drill bits, have round shanks (see, e.g., FIG. 20). In some implementations, the receiving areas 104 may all be configured to receive both hexagonal and round shanks (or even other shaped work implements). In other implementations, each of the receiving areas 104 can be specialized to receive one type of shank, such as a hexagonal shank or a round shank (e.g., FIG. 20). In an embodiment, at least one of the receiving areas 104 may be configured to receive a plurality of work implements.

Referring to FIG. 1, each bit bar 102 is defined by a body 114. The body 114 can have a single-piece construction formed, for example, from a rigid or semi-rigid polymer, a metal, an alloy, or the like. Where the body 114 is formed from a polymer, the bit bar 102 may be formed by a molding process, such as injection molding. The receiving area(s) 104 may be defined by separate recesses extending into the body 114. For example, each of the receiving areas 104 may include a cutout extending from an upper end 116 of the body 112 towards a lower end 118 of the body 114. In an embodiment, at least one of the cutouts may extend less than the full distance between the upper and lower ends 116, 118. The cutouts may define open tops 120 from which the work implement extends when the work implement is engaged with the receiving area 104. The cutouts can each have an open side 122 disposed along a sidewall 124 of the body 114, the sidewall 124 extending between the upper end 116 and the lower end 118. The open side 122 of the cutout allows the operator to translate the work implement laterally into the receiving area 104. Additionally, or alternatively, the open side 122 may allow the operator to pivot the work implement 90 degrees between a stored position and an access position. The cutouts can each define a shape that corresponds to an outer shape of the work implement receivable in the receiving area 104, such as for example, a partially-hexagonal sidewall corresponding to a hexagonal shank of a driver D.

At least one of the receiving areas 104 can include a retaining structure, such as for example, a deflectable finger 126, that selectively retains the work implement at the receiving area 104. The retaining structure can form a snap fit with the work implement. In an embodiment, at least one of the receiving areas 104 can further include guide structure, such as a ridge 128, that forms a close fit with an outer surface of the work implement to prevent rattling. Together, the retaining structure and the guide structure can support the work implement within the receiving area 104 to prevent rattling and positively engage the work implement while simultaneously permitting user access to the work implement, such as described below in greater detail. Additionally, at least one of the retaining structure and guide structure can allow the receiving area 104 to receive different types of work implements having different shapes and/or different sizes.

Lower ends of the receiving areas 104 can define pivot points 130 about which the work implement may be rotatable when inserting and removing the work implement relative to the receiving area 104. In the depicted embodiment, the pivot points 130 each include a partial-hexagonal surface that cradles a portion of a sidewall of the work implement when the work implement is pivoted 90 degrees from the receiving area 104 as described below in greater detail. The shape of each pivot point 130 may be specific to a particular work implement. Thus, for example, pivot points 130 associated with cylindrical work implement shanks may have a semi-circular surface. In an embodiment, two or more of the pivot points 130 can define the same shape such that a work implement can be swapped between different receiving areas 104.

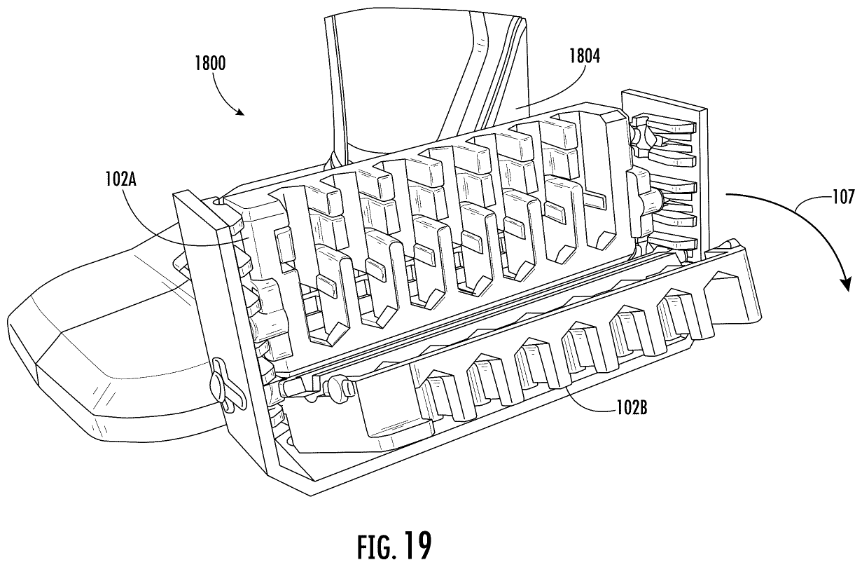

In an embodiment, the bit bar 102 can define indicia 132 that directs one or more aspects of use. For example, the indicia 132 depicted in FIG. 1 is an arrow that illustrates to the operator how to separate the second bit bar 102B from the first bit bar 102A. FIG. 1 illustrates the first and second bit bars 102A, 102B in the stacked (stored) configuration. Conversely, FIG. 19 illustrates the second bit bar 102B rotatably displaced in a direction 107 from the stacked (stored) configuration as instructed by indicia 132 (seen in FIG. 1). The indicia 130 can indicate the rotational functionality of the second bit bar 102B. The indicia 132 may alternatively, or additionally, direct the operator on how to perform a different operation, such as how to remove the work implement from the receiving area 104, how to interface the bit bar 102 with a particular tool or storage vessel, or the like.

As described in greater detail below, it may be desirable to rotate one or both of the first and second bit bars 102A, 102B. For example, an operator (user) may want to rotatably displace the second bit bar 102B from the stacked configuration to permit access to one or more work implements stored in the first bit bar 102A. To accommodate such desired access, the second bit bar 102B can rotate about an axis 134 (FIG. 2). Rotation of the second bit bar 102B can occur through a rotational interface with the first bit bar 102A or the tool and/or storage vessel as described below.

FIGS. 1 to 3 illustrate the storage system 100 in isolation, as seen

uncoupled from a tool and storage vessel. When uncoupled from the tool or storage vessel, the first and second bit bars 102A, 102B can float relative to one another. As used herein with reference to the bit bars 102, the term “float” is intended to refer to a pseudo-engagement whereby two or more objects interface with one another without positive engagement. For example, the first and second bit bars 102A, 102B can nest with one another in a stacked configuration while a force to separate the first and second bit bars 102A, 102B from one another in the unloaded state (i.e., without work implements engaged therewith) is nominal, e.g., less than 2 Newtons, less than 1 Newton, or even less than 0.1 Newton. In some instances, floating bit bars 102 may not be actively engage with one another (i.e., separation force is 0 Newtons), thereby permitting easy separation therebetween. Where the floating bit bars 102 require some nominal force to separate, the floating bit bars 102 can retain their pseudo-engagement to prevent unwanted disengagement, such as for example, when the bit bars 102 are gently placed on a surface, such as a table, without requiring that the operator exert greater than nominal force to uncouple the bit bars 102 from each other.

Alternatively, the first and second bit bars 102A, 102B can be positively engaged with one another, such as for example, via snap fit, a fastener, a bayonet connection, an adhesive, a magnetic connection, or the like. Positive engagement between the bit bars 102 allows the operator to lock two or more bit bars 102 together to form a larger (jumbo) bit bar 102. Jumbo bit bars 102 may be desirable when the lateral dimension L (FIG. 3) of the individual bit bars 102 (e.g., the first and second bit bars 102A, 102B) is required to be less than a certain size in order to interface with a particular tool. The jumbo bit bar 102 allows for storage of additional work implements on spatially constrained tools while also allowing the operator to separate the individual bit bars 102 (e.g., the first and second bit bars 102A, 102B) from one another, such as for example, to service the storage system 100 (e.g., remove debris trapped between the individual bit bars 102), or to swap between tools. When locked together, the first and second bit bars 102A, 102B act as a single unit to be moved between the tool and storage vessel as desired.

Each of the first and second bit bars 102A, 102B may include complementary structure(s) that prevent relative motion therebetween in one or more directions when the first and second bit bars 102A, 102B are stacked together. For example, the first bit bar 102A can include a projecting feature 106 (FIG. 2) that interfaces with (e.g., extends into) a cutout 108 in the second bit bar 102A. The interface formed between the projecting feature 106 and the cutout 108 can restrain relative movement between the first and second bit bars 102A, 102B in at least one direction, such as in at least two directions. For example, the projecting feature 106 and cutout 108 can constrain relative movement (e.g., sliding) between the first and second bit bars 102A, 102B in a direction B (FIG. 2). Restrained relative movement between the individual bit bars 102 can enhance locking between the storage system 100 and the tool and/or storage vessel. Where the first and second bit bars 102A, 102B are not positively engaged with one another, constraining relative movement in at least one direction may be desired for purpose of handling the storage system 100 and engaging the storage system 100 with the tool and/or storage vessel. Additionally, as described below, the projecting feature 106 may align attachment structure of the first bit bar 102A with attachment structure of the second bit bar 102B such that an interface or storage vessel that receives the storage system 100 can include a single row of complementary attachment structures that fungibly receive the first and second bit bars 102A, 102B at one or more positions.

The individual bit bars 102 (e.g., the first and second bit bars 102A, 102B) may be independently coupled to the tool and/or storage vessel or collectively coupled to the tool and/or storage vessel. In an embodiment, each of the individual bit bars 102 is separately retained at the tool or storage vessel via its own locking engagement with the tool and/or storage vessel. Alternatively, the inboard bit bar 102A may be retained solely, or in part, by interference of the outboard bit bar 102B when the outboard bit bar 102B is retained at the tool or storage vessel.

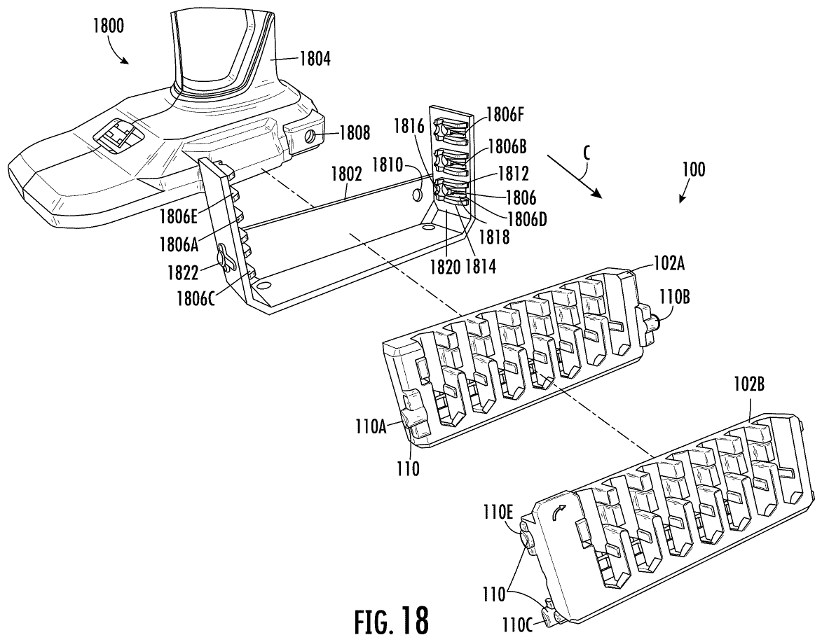

FIG. 18 illustrates a portion of a tool 1800. The depicted tool 1800 is a drill and the illustrated portion is a lower handle member of the drill. The storage system 100, or a portion thereof, may be coupled to the tool 1800 and/or another vessel via a work implement storage system receiving interface 1802 (hereinafter referred to as “the interface 1802”). The interface 1802 may include a discrete component configured to be coupled to the tool 1800, such as to a body 1804 of the tool 1800. For example, the body 1804 of the tool 1800 can include an engagement interface 1808, such as for example, a threaded opening, which receives a fastener (not illustrated). The fastener can pass through an opening 1810 in the interface 1802 and be threadably received by the threaded opening. When tightened to the threaded opening, the fastener can retain the interface 1802 at the tool 1800. By way of non-limiting example, engagement between the tool 1800 and the interface 1802 can alternatively, or additionally, include a snap fit, a clip, a bayonet type engagement, a sliding rail engagement, an adhesive, an interference fit, a non-threaded fastener engagement, a hook and loop fastener, or the like. Alternatively, the interface 1802 may be unitary with the body 1804 of the tool 1800 or a component coupled to the tool 1800 for another purpose-such as a removable battery (not illustrated). In some implementations, the interface 1802 can include a plurality of different engagement types in addition to, or alternative to, the opening 1810 such that a single interface 1802 can be used with different types of tools 1800 having different types of interface engagements 1808.

The interface 1802 includes an attachment structure 1806 configured to interface with a complementary attachment structure 110 of the storage system 100 (FIG. 1) to selectively and removably couple the storage system 100 to the interface 1802, and thereby couple the storage system 100 to the tool 1800. The attachment structure 1806 can include a first (e.g., left) attachment structure 1806A and a second (e.g., right) attachment structure 1806B. The first attachment structure 1806A can interface with a first complementary attachment structure 110A of the storage system 100 and the second attachment structure 1806B can interface with a second complementary attachment structure 110B of the storage system 100.

As described above, the first and second bit bars 102A, 102B can each be individually coupled to the tool 1800. For example, the first and second bit bars 102A, 102B can each include complementary attachment structures 110 that separately interface with attachment structures 1806 of the interface 1802. By way of non-limiting example, the first bit bar 102A can include a first complementary attachment structure 110A and a second complementary attachment structure 110B. The first complementary attachment structure 110A can interface with the first attachment structure 1806A and the second complementary attachment structure 110B can interface with the second attachment structure 1806B. The second bit bar 102B can include a first complementary attachment structure 110C and a second complementary attachment structure 110D (see FIG. 3). The first and second complementary attachment structures 110C, 110D of the second bit bar 102B can interface with third and fourth attachment structures 1806C, 1806D of the interface 1802. The second bit bar 102B can further include a third complementary attachment structure 110E and a fourth complementary attachment structure 110F (see FIG. 3). The third and fourth complementary attachment structures 110E, 110F can interface with fifth and sixth attachment structures 1806E, 1806F of the interface 1802. While the interface 1802 depicted in FIG. 18 includes only three sets of attachment structures 1806A and 1806B, 1806C and 1806D, and 1806E and 1806F, it is contemplated that the interface 1802 can further include additional attachment structures that receive additional bit bars 102 and/or allow for various mounting positions of the respective bit bars 102.

In an embodiment, when the storage system 100 is stacked for engagement with the tool 1800 (or storage vessel described below), the complementary attachment structure 110A of the first bit bar 102A can be disposed between the attachment structures 110C, 110E of the second bit bar 102B and the complementary attachment structure 110B of the first bit bar 102A can be disposed between the attachment structures 110D, 110F of the second bit bar 102B. This arrangement can satisfy the above-described situation where the projection 106 of the first bit bar 102A (e.g., the complementary attachment structures 110A, 110B) fits within the groove 108 of the second bit bar 102B (e.g., the gaps between the complementary attachment structures 110C, 110E and between 110D, 110F).

The storage system 100 may allow for independent installation and removal of the first and second bit bars 102A, 102B from the interface 1802. For example, the second bit bar 102B may be removed first from the interface 1802 by translating the second bit bar 102B in a direction C followed subsequently by removing the first bit bar 102A by translating the first bit bar 102A in the same direction C. The first bit bar 102A may remain coupled to the interface 1802 while the second bit bar 102B is removed therefrom. Alternatively, the first and second bit bars 102A, 102B can be removed from the interface 1802 simultaneously by translating the first and second bit bars 102A, 102B together in the direction C. Reinstalling the storage system 110 on the interface 1802 can be performed be individually installing the first and second bit bars 102A, 102B. For example, the operator can individually install the first bit bar 102A on the interface 1802. After the first bit bar 102A is engaged with the interface 1802, the operator can then install the second bit bar 102B with the interface 1802. In some instances, the operator may only require the use of one bit bar and may only install the first bit bar 102A or the second bit bar 102B at the interface 1802. Alternatively, the first and second bit bars 102A, 102B can be installed on the interface 1802 simultaneously by translating the first and second bit bars 102A, 102B in a direction opposite the direction C.

The attachment structure 1806 and the complementary attachment structure 110 may interface together to secure the storage system 100 at the interface 1802 through sliding engagement. For example, the attachment structures 1806 can each include a first rail 1812 and a second rail 1814. The first and second rails 1812, 1814 may be spaced apart by a distance corresponding to a dimension of the complementary attachment structure 110 such that the complementary attachment structure 110 (or a portion thereof) can slide between the first and second rails 1812, 1814 until reaching a locked position at least partially defined by a stop 1816. The stop 1816 may include a sidewall extending between the first and second rails 1812, 1814. A ramp 1818 may be disposed between the first and second rails 1812, 1814 and extend towards the stop 1816. During installation of the storage system 100 at the interface 1802, the complementary attachment structure 110 can ride along the ramp 1818 and snap into the locked position after passing over the end of the ramp 1818. The ramp 1818 may include two ramped segments spaced apart from one another and running parallel with respect to one another. The two ramped segments may form a groove therebetween in which the complementary attachment structure 110 rides during installation. A sidewall 1820 of the interface 1802 to which the attachment structure 1806 extends from may flex during installation of the storage system 100 to accommodate the complementary attachment structure 110 interfering with the ramp 1818. In some instances, the operator may experience an indication (e.g., a tactile indication and/or an audible indication) when the complementary attachment structure 110 reaches and seats at the locked position.

In some implementations, the interface 1802 remains fixed to the tool 1800. However, the interface 1802 need not remain permanently fixed to the tool 1800. For example, it may be desirable to remove the interface 1802 from the tool 1800 when performing operations that require dexterity or unusual hand placement on the tool 1800. As previously described, the bit bars 102 may be stored in a storage vessel when not actively engaged with the interface 1802. Similarly, the interface 1802 may be stored in the same or different storage vessel when not actively engaged with the tool 1800. The interface 1802 can include a storage vessel interfacing component 1822 that engages with the storage vessel. The storage vessel interfacing component 1822 may include two components located on opposite sidewalls 1820.

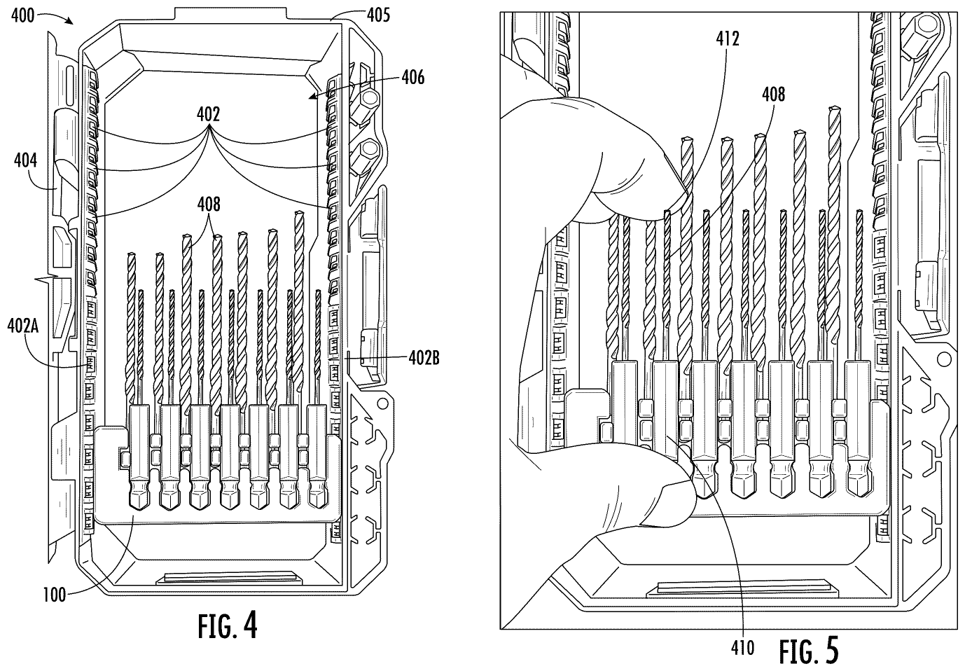

FIGS. 4 to 11 illustrate a storage vessel 400 in accordance with an example embodiment. The storage vessel 400 may include a plurality of storage positions, each of which can retain the storage system 100. Each of the storage positions may be defined by a pair of attachment structures 402. The attachment structures 402 may be the same, or similar, as the attachment structures 1806 described with respect to the interface 1802. For example, the storage vessel 400 can include a plurality of attachment structures 402, each having the same size and shape as compared to the attachment structure 1806. Each pair of attachment structures 402 (e.g., attachment structures 402A, 402B) can together capture the storage system 100 so as to retain the storage system 100 at a fixed position with respect to the storage vessel 400. In such a manner, the storage system 100 may be interchangeably coupled between the interface 1802 and the storage vessel 400, thereby allowing a user to quickly swap the tool 1800 between different storage systems 100 in view of a work operation to be conducted using the tool 1800 and also allowing the user to store unused storage systems 100 to prevent environmental exposure (e.g., rusting, contamination, etc.) and to maintain a clean operating area.

Referring initially to FIG. 4, the storage vessel 400 is depicted in an open state, i.e., with a cover 404 of the storage vessel 400 in an open position, allowing access to an internal volume 406 defined by the cover 404 and a base 405. The attachment structures 402 are accessible when the cover 404 is in the open position. As depicted in FIG. 4, the storage system 100 is in a stored position relative to the storage vessel 400. With the storage system 100 in the stored position, the cover 404 may be closed. As described below, the storage system 100 may be rotated to an activated position in which the storage system 100 may interfere with closure of the cover 404.

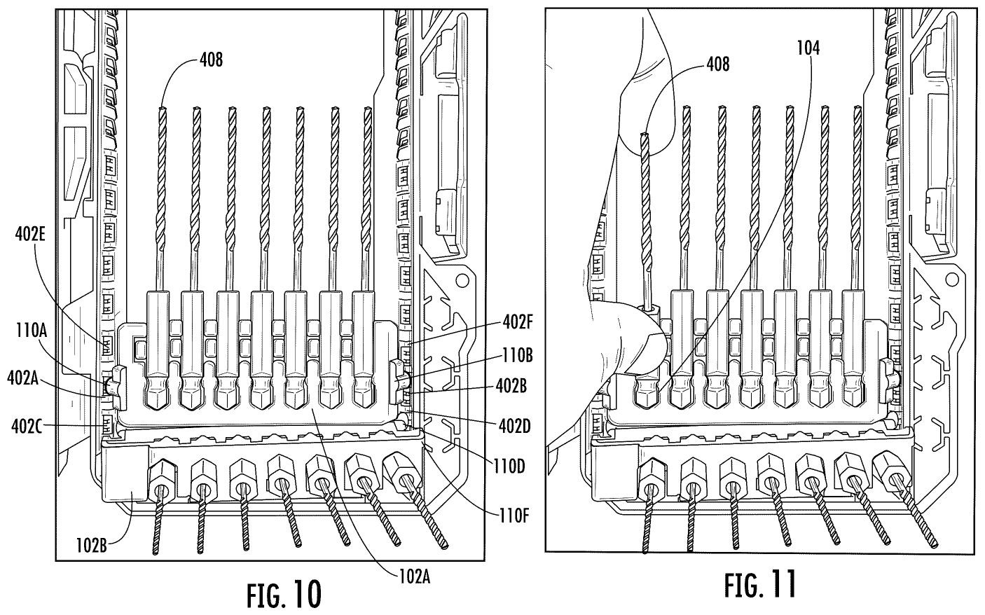

Referring to FIG. 10, the first and second complementary attachment structures 110A, 110B of the first bit bar 102A can interface with a first pair of attachment structures 402A, 402B. The first and second complementary attachment structures 110C, 110D of the second bit bar 102B can interface with a second pair of attachment structures 402C, 402D. The third and fourth complementary attachment structures 110E, 110F of the second bit bar 102B can interface with a third pair of attachment structures 402E, 402F. As depicted, the first complementary attachment structure 110A of the first bit bar 102A can be disposed between the first and third complementary attachment structure 110C, 110E of the second bit bar 102B and the second complementary attachment structure 110B of the first bit bar 102A can be disposed between the second and fourth complementary attachment structure 110D, 110F of the second bit bar 102B when the first and second bit bars 102A, 102B are both fully engaged with the attachment structure 402 of the storage vessel 400 in the stored position.

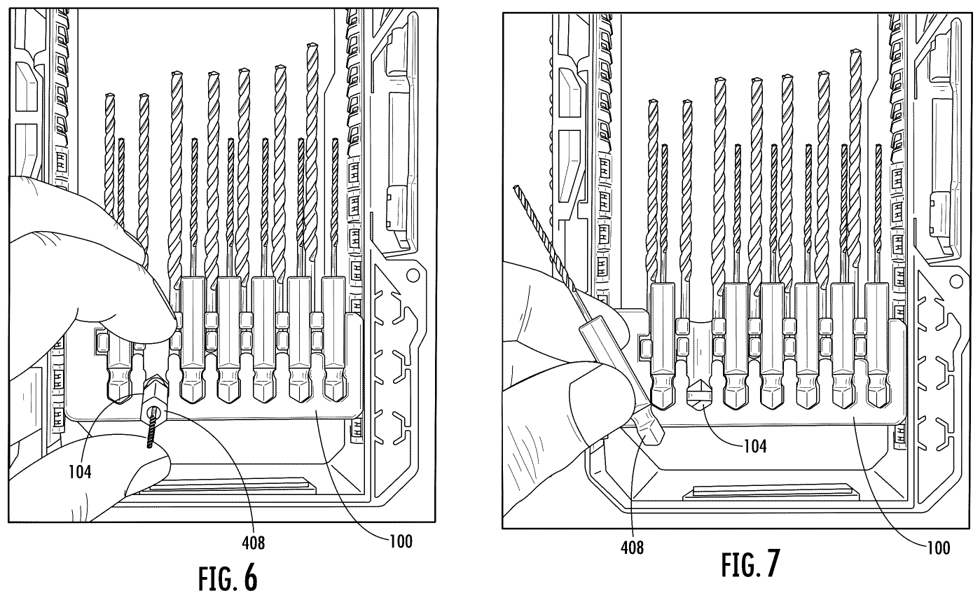

When a particular work implement 408 (such as a drill bit) is desired, the user can move the desired work implement 408 from the stored position relative to the storage system 100 (e.g., as depicted in FIG. 4) to an access position (e.g., as depicted in FIG. 6). To move the desired work implement 408 from the stored position (FIG. 4) to the access position (FIG. 6), the user selects the work implement 408, and presses down on a shank 410 of the work implement 408 and/or lifts an accessible end 412 of the work implement 408 as depicted in FIG. 5. By applying lifting force to the accessible end 412 of the work implement 408, the user can cause the work implement 408 to pivot (fulcrum) about the shank 410 from the stored position to the access position. Referring again to FIG. 1, at least one of the receiving areas 104 of the bit bars 102 can include an overhang surface 112. The overhang surface 112 can extend over the work implement 408 (and more particularly over a lowermost portion of the shank 410 of the work implement 408) to restrict movement of the shank 410, e.g., while the work implement 408 is rotated. In particular, the overhang surface 112 can prevent the work implement 408 from prematurely pulling out of the receiving area 104 while the work implement 408 is rotated from the stored position to the access position. The user can overcome the overhang surface 112 and prematurely remove the work implement 408 from the receiving area 104 by imparting a force to the work implement 408 that pulls the shank 410 out from under the overhang surface 112. Such force may be applied in a direction generally parallel with a length of the work implement 408.

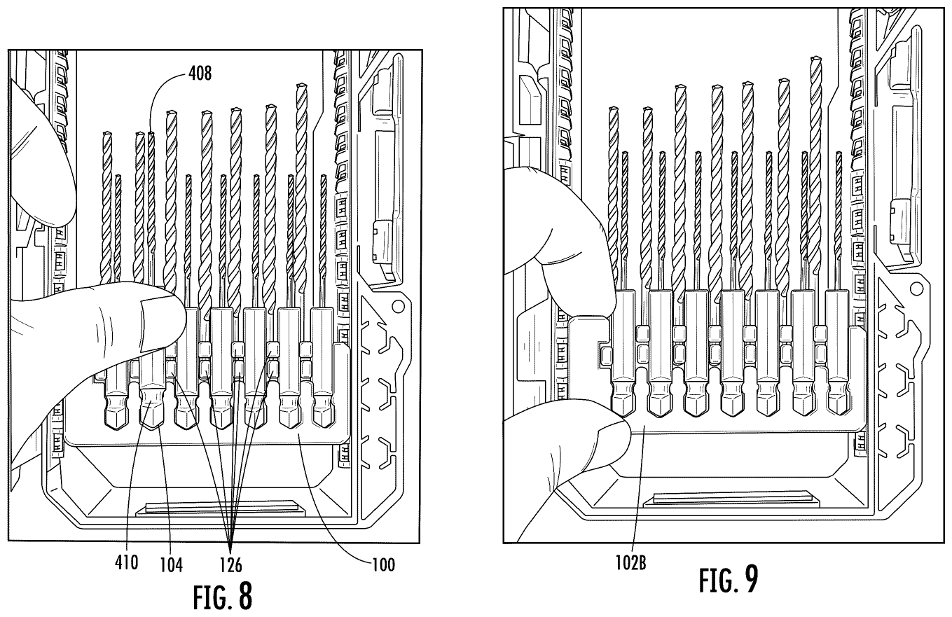

The work implement 408 is rotated from the stored position (FIG. 4) to the access position (FIG. 6) by rotating the work implement 408 at least 10°, such as at least 20°, such as at least 40°, such as at least 60°, such as at least 80°. In an embodiment, the stored position and the access position can be angularly offset from one another by approximately 90°. The receiving area 104 of the storage system 100 can be configured to maintain the work implement 408 in the access position as depicted in FIG. 6 until the operator removes the work implement 408 as shown in FIG. 7. After use, the work implement 408 can be returned to the receiving area 104 and rotated to the stored position as depicted in FIG. 8. The user can press on the shank 410 or another portion of the work implement 408 until the work implement 408 snaps fully into the receiving area 104. In some instances, fingers 126 disposed adjacent to the receiving area 104 can deflect to permit passage of the work implement 408 into the receiving area 104. The fingers 126 can return to an unbiased position (or another position between the unbiased position and a fully flexed position encountered when the work implement 408 is passing by the fingers 126) to lock the work implement 408 in the receiving area 104.

In some instances, the desired work implement 408 can be disposed in the first (inboard) bit bar 102A and not the immediately accessible second (outboard) bit bar 102B. To access work implements 408 from the first bit bar 102A, the user can grasp the second bit bar 102B (e.g., as depicted in FIG. 9) and adjust a position of the second bit bar 102B from a first position (FIG. 9) to a second position (FIG. 10) to grant access to work implements 408 retained by the first bit bar 102A. The first and second positions may be offset by rotation of the second bit bar 102B. Referring to FIGS. 9 and 10, the user can rotate the second bit bar 102B about an axis formed by the first and second complementary attachment structures 110C, 110D (FIGS. 3 and 10). Initially, the second bit bar 102B may be retained at the first rotational position by the third and fourth complementary attachment structures 110E, 110F of the second bit bar 102B (FIG. 1). Upon initiating rotation of the second bit bar 102B from the position depicted in FIG. 9, the third and fourth complementary attachment structures 110E and 110F disengage from the associated attachment structure 402 of the storage vessel 400, allowing the second bit bar 102B to rotate about the axis formed by the first and second complementary attachment structures 110C, 110D. The user can continue rotating the second bit bar 102B from the first rotational position depicted in FIG. 9 to the second rotational position depicted in FIG. 10, whereby the work implements 408 in the first bit bar 102A become more easily accessible. In some instances, the storage system 100, and more particularly the second bit bar 102B, can snap into the second rotational position and remain in the second rotational position via a detent or structural interface formed between the second bit bar 102B and the attachment structure 402. Once the second bit bar 102B is in the second rotational position, the user can access the desired work implement 408 from the first bit bar 102A as depicted in FIG. 11 and remove the desired work implement 408 from the receiving area 104 of the first bit bar 102A in a manner as described above with respect to FIGS. 5 to 7. The user can return the working implement 408 to the storage system 100 as described above with respect to FIG. 8. The second bit bar 102B can be rotated back from the second rotational position to the first rotational position to allow the cover 404 to return to the closed position.

In another embodiment, the user can entirely remove the second bit bar 102B from the storage vessel 400 to allow access to the first bit bar 102A. For instance, rather than rotating the second bit bar 102B about the axis formed by the complementary attachment structures 110C, 110D (or in addition to such rotation), the user can completely detach the complementary attachment structures 110C, 110D from the storage vessel 400, thereby allowing the user to remove the second bit bar 102B from the storage vessel 400 and provide access to the underlying first bit bar 102A. To detach the second bit bar 102B from the storage vessel 400, the user may detach the first and second complementary attachment structures 110C, 110D from the attachment structures 402 in addition to detaching the third and fourth complementary attachment structures 110E, 110F from the attachment structures 402. With the second bit bar 102B detached, the user has access to the work implements 408 retained by the first bit bar 102A. The user can replace the second bit bar 102B using an inverse process when access to the first bit bar 102A is no longer needed.

FIGS. 12 to 14 depict an embodiment of a storage system 1200 in accordance with another embodiment. The storage system 1200 can share any one or more common features or attributes as described above with respect to the storage system 100. For example, the storage system 1200 may be configured to interface with attachment structures 1806 of the interface 1802 and/or the attachment structures 402 of the storage vessel 400. In this regard, the storage system 1200 can include one or more complementary attachment structures 1202 that interface with the attachment structures 1806 and/or 402 to allow the storage system 1200 to be removably coupled to the tool 1800 and/or storage vessel 400. The complementary attachment structures 1202 can include one or more first complementary attachment structures 1202A and one or more second complementary attachment structures 1202B, similar or substantially similar to the first and second complementary attachment structures 110A, 110B.

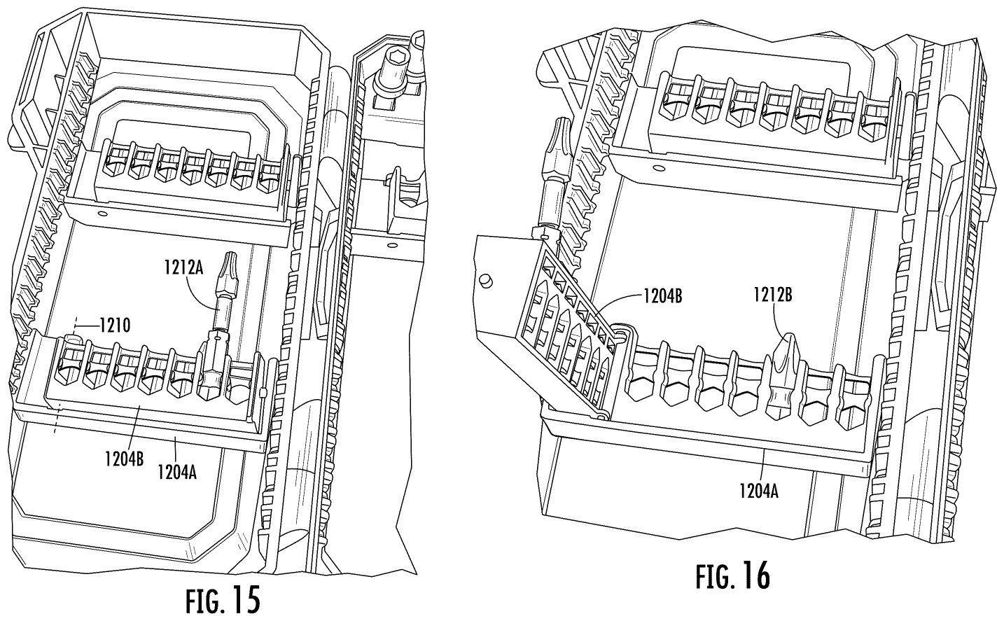

The storage system 1200 generally includes a first bit bar 1204A defining the complementary attachment structures 1202 and a second bit bar 1204B coupled to the first bit bar 1204A. In an embodiment, the second bit bar 1204B is coupled to the tool 1800 (FIG. 18) or storage vessel 400 (e.g., FIGS. 15 to 17) through the first bit bar 1204A. The second bit bar 1204B can be movably coupled, e.g., rotatably coupled, to the first bit bar 1204A. For instance, the second bit bar 1204B can define an axle 1206 that is rotationally supported by one or more pivot points 1208 (e.g., openings) defined by the first bit bar 1204A. The axle 1206 can rotate relative to the pivot point(s) 1208 about an axis 1210 between a first rotational position as depicted in FIG. 12 and a second rotational position as depicted in FIG. 16. Yet other rotational positions, such as rotational positions between the first and second rotational positions, may be achieved.

The first and second bit bars 1204A and 1204B can each define receiving areas 1212 each configured to receive at least one work implement (such as the driver D depicted in FIG. 12). Work implements captured and retained by receiving areas 1212 in the first bit bar 1204A may be covered by work implements captured and retained by receiving areas in the second bit bar 1204B when the second bit bar 1204B is in the first rotational position as depicted in FIG. 12. To access the work implements from the first bit bar 1204A, the second bit bar 1204B can be rotated from the first rotational position to the second rotational position about the axis 1210. FIGS. 15 and 16 depict an example process of accessing work implements from the first bit bar 1204A.

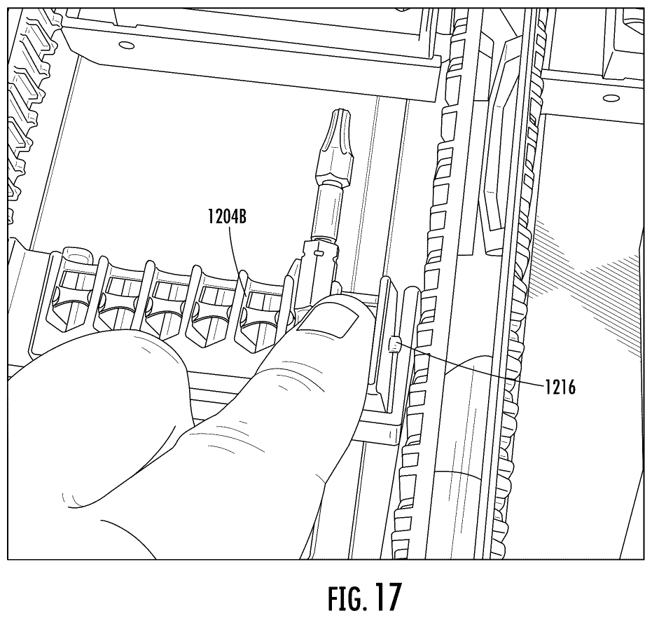

Referring initially to FIG. 15, the second bit bar 1204B is in a first rotational position. The second bit bar 1204B includes a first work implement 1212A that is accessible with the second bit bar 1204B in the first rotational position. To access a second work implement 1212B (FIG. 16) retained by the first bit bar 1204A, the user rotates the second bit bar 1204B about the axis 1210 from the first position (FIG. 15) to the second position as depicted in FIG. 16, whereby the user can access the second work implement 1212B. Once access to the first bit bar 1204A is no longer required, the user can rotate the second bit bar 1204B back to the first position as depicted in FIG. 17. Referring to FIGS. 13, 14, and 17, the first bit bar 1204A can define a first detent structure 1214 and the second bit bar 1204B can define a second detent structure 1216 configured to interface with the first detent structure 1214 to maintain the second bit bar 1204B in the first rotational position. In an embodiment, the first detent structure 1214 includes a projection and the second detent structure 1216 includes a recess in which the projection is receivable. At least one of the first and second bit bars 1204A or 1204B (or a portion thereof) can flex to allow the projection of the first detent structure 1214 to clear the recess of the second detent structure 1216, thereby allowing rotation of the second bit bar 1204B about the axis 1210. In an embodiment, the projection and recess are inverted such that the first detent structure 1214 includes a recess and the second detect structure 1216 includes the projection. Yet other complementary interfaces are contemplated herein that allow a user to temporarily lock the second bit bar 1204B in the first rotational position with respect to the first bit bar 1204A.

In an embodiment, the storage vessel 400 can support bit bars 102, 1204 in only one of the base 405 or the cover 404. In another embodiment, the storage vessel 400 can support bit bars 102, 1204 in each of the base 405 and the cover 404. In some instances, the base 405 may be used to support one type of the bit bars 102, 1204 and the cover 404 may be used to support the other type of the bit bars 102, 1204. In some instances, the bit bars 102, 1204 may be interchangeable between the base 405 and the cover 404.

Further aspects of the invention are provided by one or more of the following embodiments:

Embodiment 1. A tool or storage vessel comprising: a body; an interface coupled to the body and including an attachment structure; a work implement storage system removably coupled to the interface, wherein the work implement storage system comprises: a first member defining a first plurality of receiving areas each configured to receive one of a plurality of work implements; and a second member defining a second plurality of receiving areas each configured to receive one of the plurality of work implements, wherein the first and second members are stacked together when the work implement storage system is coupled to the interface such that the first member is disposed between the second member and the tool or storage vessel, and wherein the second member is rotatable relative to the interface to permit user access to one or more of the work implements received in the first plurality of receiving areas.

Embodiment 2. The tool or storage vessel of embodiment 1, wherein the first member is an inboard member, wherein the second member is an outboard member, and wherein the second member is rotatable relative to the first member about a rotational axis defined entirely by the first and second members.

Embodiment 3. The tool or storage vessel of embodiment 1, wherein the first member is an inboard member, wherein the second member is an outboard member, and wherein the second member is rotatable relative to the first member about a rotational axis defined between the interface and the second member.

Embodiment 4. The tool or storage vessel of any one or more of embodiments 1 to 3, wherein the interface comprises a plurality of attachment structures disposed in a row, wherein the first member comprises a first complementary attachment structure, wherein the second member comprises a second complementary attachment structure and a third complementary attachment structure, wherein the first complementary attachment structure is disposed between the second and third complementary attachment structures when the work implement storage system is coupled to the interface, and wherein the first member nests relative to the second member such that each of the first, second, and third complementary attachment structures interfaces with one attachment structure of the row of attachment structures of the interface.

Embodiment 5. The tool or storage vessel of embodiment 4, wherein the second member is rotatable relative to the interface about the third complementary attachment structure.

Embodiment 6. The tool or storage vessel of any one or more of embodiments 1 to 5, wherein the interface comprises a plurality of attachment structures each comprising: a first rail; a second rail extending parallel to the first rail; a stop extending between the first and second rails; a ramp; and a locking position defined by the first rail, the second rail, the stop, and the ramp, wherein the first and second members each comprise a complementary attachment structure that is removably received in the locking position of one of the plurality of attachment structures to removably retain the first and second members at the interface.

Embodiment 7. The tool or storage vessel of any one or more of embodiments 1 to 6, wherein the first plurality of receiving areas each include a recess extending into a body of the first member, and wherein each of the plurality of work implements stored in the first plurality of receiving areas is removed from a respective recess by rotating the work implement about a pivot point and then translating the work implement from the recess.

Embodiment 8. A work implement storage system comprising: a first member comprising: a body defining a first plurality of receiving areas each configured to receive a work implement of a plurality of work implements; and a first attachment structure; a second member comprising: a body defining a second plurality of receiving areas each configured to receive another work implement of the plurality of work implements; a second attachment structure; and a third attachment structure, wherein the first and second members stack relative to one another, wherein in a stacked state the first attachment structure is disposed between the second and third attachment structures, and wherein the first, second, and third attachment structures are configured to couple the first and second members to a tool or storage vessel.

Embodiment 9. The work implement storage system of embodiment 8, wherein the second member is configured to rotate relative to the tool or storage vessel when coupled therewith, and wherein the second member is configured to rotate relative to the tool or storage vessel about a rotational axis defined by the third attachment structure.

Embodiment 10. The work implement storage system of embodiment 8, wherein the second and third attachment structure rotatably couple the second member to the first member about a rotational axis.

Embodiment 11. The work implement storage system of embodiment 10, wherein the second member is selectively lockable in the stacked state.

Embodiment 12. The work implement storage system of any one or more of embodiments 10 or 11, wherein the second member is configured to couple to the tool or storage vessel through the first member.

Embodiment 13. The work implement storage system of any one or more of embodiments 8 to 12, wherein the second member is rotatable relative to the tool or storage vessel while the first member remains relatively fixed with respect to the tool or storage vessel, and wherein rotation of the second member from a stored position to an access position permits user access to the work implements in the first plurality of receiving areas.

Embodiment 14. The work implement storage system of embodiment 13, wherein user access to the work implements in the first plurality of receiving areas is restricted when the second member is in the stored position.

Embodiment 15. The work implement storage system of any one or more of embodiments 8 to 14, wherein the first attachment structure is configured to engage a complementary attachment structure associated with the tool or storage vessel, the complementary attachment structure comprising: a first rail; a second rail extending parallel to the first rail; a stop extending between the first and second rails; a ramp; and a locking position disposed between the first rail, the second rail, the stop, and the ramp, wherein the attachment structure is removably received in the locking position to removably retain the work implement storage system at the tool or storage vessel.

Embodiment 16. The work implement storage system of any one or more of embodiments 8 to 15, wherein the first attachment structure comprises a set of first attachment structures disposed on opposite sides of the first member, wherein each of the second and third attachment structures comprises a set of second and third attachment structures disposed on opposite sides of the second member, and wherein the first, second, and third sets of attachment structures are fungible.

Embodiment 17. A method of using a tool, the method comprising:

selecting a desired work implement for use with a tool based on a work operation; identifying a location of the desired work implement in an inboard member of a work implement storage system coupled to the tool or a storage vessel; rotatably displacing an outboard member of the work implement storage system to provide user access to the inboard member; pivoting the desired work implement relative to a receiving area in which the desired work implement is disposed from a stored position to an access position; withdrawing the desired work implement from the receiving area with the desired work implement in the access position; rotatably displacing the outboard member to an original position; and using the tool with the desired work implement to perform the work operation.

Embodiment 18. The method of embodiment 17, wherein rotatably displacing the outboard member is performed without removing the outboard member from the tool or storage vessel, and wherein a component of the outboard member about which the outboard member rotates is part of a connection interface that retains coupled engagement between the outboard member and the tool or storage vessel.

Embodiment 19. The method of any one or more of embodiments 17 or 18, further comprising reinserting the desired work implement into the receiving area by: rotatably displacing the outboard member to provide user access to the inboard member; inserting the desired work implement into the receiving area of the inboard member and pivoting the desired work implement to a stored position; and rotatably displacing the outboard member to the original position.

Embodiment 20. The method of any one or more of embodiments 17 to 19, wherein the work implement storage system is detachable from the tool or storage area.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A tool or storage vessel comprising:
a body;
an interface coupled to the body and including an attachment structure;
a work implement storage system removably coupled to the interface, wherein the work implement storage system comprises:
a first member defining a first plurality of receiving areas each configured to receive one of a plurality of work implements;
and
a second member defining a second plurality of receiving areas each configured to receive one of the plurality of work implements,
wherein the first and second members are stacked together when the work implement storage system is coupled to the interface such that the first member is disposed between the second member and the tool or storage vessel, and wherein the second member is rotatable relative to the interface to permit user access to one or more of the work implements received in the first plurality of receiving areas.

2. The tool or storage vessel of claim 1, wherein the second member is rotatable relative to the first member about a rotational axis defined entirely by the first and second members.

3. The tool or storage vessel of claim 1, wherein the second member is rotatable relative to the first member about a rotational axis defined directly between the interface and the second member.

4. The tool or storage vessel of claim 1, wherein the interface comprises a plurality of attachment structures disposed in a row, wherein the first member comprises a first complementary attachment structure, wherein the second member comprises a second complementary attachment structure and a third complementary attachment structure, wherein the first complementary attachment structure is disposed between the second and third complementary attachment structures when the work implement storage system is coupled to the interface, and wherein the first member nests relative to the second member such that each of the first, second, and third complementary attachment structures interfaces with one attachment structure of the row of attachment structures of the interface.

5. The tool or storage vessel of claim 4, wherein the second member is rotatable relative to the interface about the third complementary attachment structure.

6. The tool or storage vessel of claim 1, wherein the interface comprises a plurality of attachment structures each comprising:
a first rail;
a second rail extending parallel to the first rail;
a stop extending between the first and second rails;
a ramp; and
a locking position defined by the first rail, the second rail, the stop, and the ramp,
wherein the first and second members each comprise a complementary attachment structure that is removably received in the locking position of one of the plurality of attachment structures to removably retain the first and second members at the interface.

7. The tool or storage vessel of claim 1, wherein the first plurality of receiving areas each include a recess extending into a body of the first member, and wherein each of the plurality of work implements stored in the first plurality of receiving areas is removed from a respective recess by rotating the work implement about a pivot point and then translating the work implement from the recess.

8. A work implement storage system comprising:
a first member comprising:
a body defining a first plurality of receiving areas each configured to receive a work implement of a plurality of work implements;
and
a first attachment structure;
a second member comprising:
a body defining a second plurality of receiving areas each configured to receive another work implement of the plurality of work implements;
a second attachment structure; and
a third attachment structure,
wherein the first and second members stack relative to one another, wherein in a stacked state the first attachment structure is disposed between the second and third attachment structures, and wherein the first, second, and third attachment structures are configured to couple the first and second members to a tool or storage vessel.

9. The work implement storage system of claim 8, wherein the second member is configured to rotate relative to the tool or storage vessel when coupled therewith, and wherein the second member is configured to rotate relative to the tool or storage vessel about a rotational axis defined by the third attachment structure.

10. The work implement storage system of claim 8, wherein the second and third attachment structure rotatably couple the second member to the first member about a rotational axis.

11. The work implement storage system of claim 10, wherein the second member is selectively lockable in the stacked state.

12. The work implement storage system of claim 10, wherein the second member is configured to couple to the tool or storage vessel through the first member.

13. The work implement storage system of claim 8, wherein the second member is rotatable relative to the tool or storage vessel while the first member remains relatively fixed with respect to the tool or storage vessel, and wherein rotation of the second member from a stored position to an access position permits user access to the work implements in the first plurality of receiving areas.

14. The work implement storage system of claim 13, wherein user access to the work implements in the first plurality of receiving areas is restricted when the second member is in the stored position.

15. The work implement storage system of claim 8, wherein the first attachment structure is configured to engage a complementary attachment structure associated with the tool or storage vessel, the complementary attachment structure comprising:
a first rail;
a second rail extending parallel to the first rail;
a stop extending between the first and second rails;
a ramp; and
a locking position defined by the first rail, the second rail, the stop, and the ramp,
wherein the first attachment structure is removably received in the locking position to removably retain the work implement storage system at the tool or storage vessel.

16. The work implement storage system of claim 8, wherein the first attachment structure comprises a set of first attachment structures disposed on opposite sides of the first member, wherein the second and third attachment structures comprise sets of second and third attachment structures disposed on opposite sides of the second member, and wherein the first, second, and third sets of attachment structures are fungible and disposed along a common plane when the first and second members are in the stacked state.

17. A method of using a tool, the method comprising:
selecting a desired work implement for use with a tool based on a work operation;
identifying a location of the desired work implement at an inboard member of a work implement storage system coupled to the tool or a storage vessel;
rotatably displacing an outboard member of the work implement storage system to provide access to the inboard member;
pivoting the desired work implement relative to a receiving area in which the desired work implement is disposed from a stored position to an access position;
withdrawing the desired work implement from the receiving area with the desired work implement in the access position;
rotatably displacing the outboard member to an original position; and
using the tool with the desired work implement to perform the work operation.

18. The method of claim 17, wherein rotatably displacing the outboard member is performed without removing the outboard member from the tool or storage vessel, and wherein a component of the outboard member about which the outboard member rotates is part of a connection interface that retains coupled engagement between the outboard member and the tool or storage vessel.

19. The method of claim 17, further comprising reinserting the desired work implement into the receiving area by:
rotatably displacing the outboard member to provide user access to the inboard member;
inserting the desired work implement into the receiving area of the inboard member and pivoting the desired work implement to a stored position; and
rotatably displacing the outboard member to the original position.

20. The method of claim 17, wherein the work implement storage system is detachable from the tool or storage area.
